(19) United States
(12) Patent Application Publication
(10) Pub. No.: US 2004/0179112 A1
(43) Pub. Date: Sep. 16, 2004

(54) Digital camera

(76) Inventor: Ga-Lane C. Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/800,041

(22) Filed: Mar. 12, 2004

(30) Foreign Application Priority Data
Mar. 12, 2003 (TW) 92105299

(51) Int. Cl. G02B 15/14

(52) U.S. Cl. 348/222.1

(57) ABSTRACT

A digital camera (10) includes an image sensor module (20), a Digital Signal Processor (DSP) (30), an Microprogrammed Control Unit (MCU) (40), a Dynamic Random Access Memory (DRAM) (50), an output apparatus (60), and a printed circuit board (PCB) for connecting all of the above components together. The image sensor module comprises a camera lens (21) seated on an image sensor (23). The camera lens has a non-spherical surface. Optical signals are transformed to analog signals in an image sensor, the analog signals are transformed into digital signals by the DSP, and the digital signals are processed by the MCU. The DRAM (50) is used for storing data for the MCU.

### BACKGROUND OF THE INVENTION

1. Field of the Invention

The present invention generally relates to digital cameras, and more particularly to a digital camera with a compact structure.

2. Prior Art

Currently, with development of multimedia technology, digital cameras are widely used by people.

Current digital cameras usually include a lens, a CCD/CMOS image sensor, a Digital Signal Processor (DSP) and a Microprogrammed Control Unit (MCU). The lens includes a drawtube, with a front convex lens, an infrared filter, an aperture loop and a back convex lens therein in order.

The long focal length of the front convex lens will make the drawtube long, and a distance between the aperture loop and the infrared filter, and the distance between the aperture loop and the back convex lens, will further contribute to making the drawtube long. So a size of the digital camera will be relatively large, and the digital camera will be hard to combine with a mobile phone or Personal Digital Assistant (PDA). On the other hand, the optical capability of the digital camera will suffer from optical aberration of all spherical lenses, so the imaging effect will be bad.

One micro lens is disclosed in China Application No. 01204310, which includes a drawtube with lenses therein, an aperture loop, and an infrared filter. The lenses include a front convex lens and a back convex lens. The front convex lens, the aperture loop, the infrared filter and the back convex lens are set in the drawtube in order. The micro lens is designed to shorten the length of the drawtube by using the convex lenses, but its size is still large due to so many lenses, and its optical capability shows no improvement.

Therefore, a digital camera with a more compact structure is desired.

### SUMMARY OF THE INVENTION

Accordingly, an object of the present invention is to provide a digital camera with a compact structure.

To achieve the above-mentioned object, a digital camera includes an image sensor module, a DSP for transforming analog signals to digital signals, a MCU for processing signals coming from the DSP, a DRAM for sharing data for the operational processing of the MCU, an output apparatus, and circuitry connecting all the above detailed elements together. The image sensor module, which transforms optical signals to analog signals, includes a sensor and a lens with a non-spherical surface therein.

### BRIEF DESCRIPTION OF THE DRAWINGS

FIG. 1 is a schematic diagram of the digital camera in accordance with a preferred embodiment of the present invention; and

FIG. 2 is a schematic diagram of the image sensor module of the digital camera of the present invention.

### DETAILED DESCRIPTION OF THE INVENTION

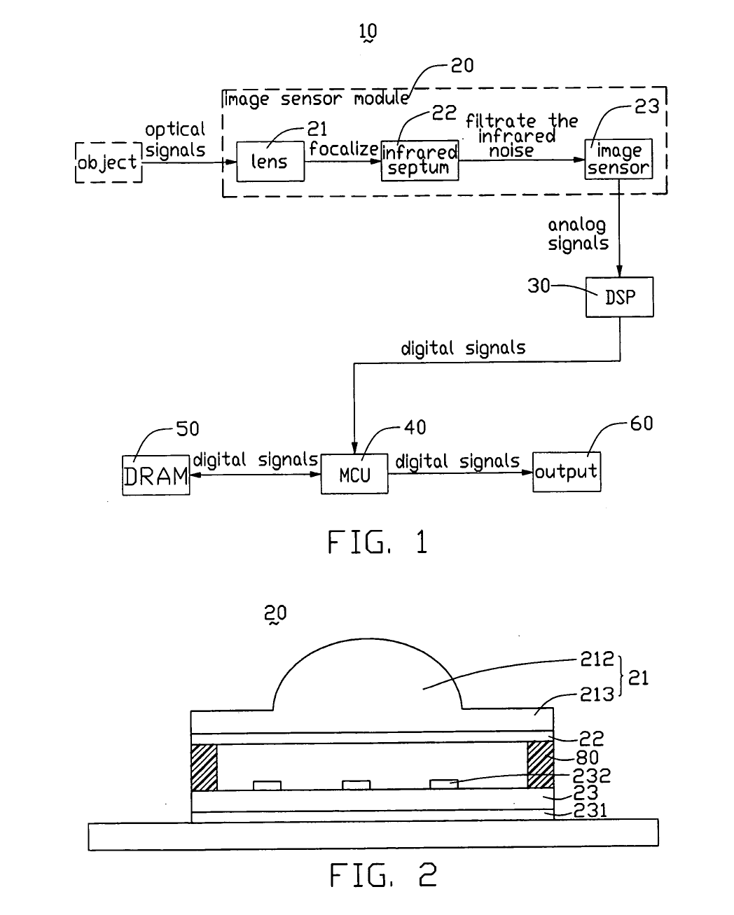

Referring to FIG. 1, a digital camera 10 includes an image sensor module 20 for transforming optical signals to analog signals, a Digital Signal Processor (DSP) 30 for transforming analog signals to digital signals, a Microprogrammed Control Unit (MCU) 40, a Dynamic Random Access Memory (DRAM) 50 for storing data from the MCU 40, and an output apparatus 60. The digital camera 10 further includes a printed-circuit board (PCB) (not shown), integrating the image sensor module 20, the DSP 30, the MCU 40, the DRAM 50, and the output apparatus 60 together.

Referring to FIGS. 1 and 2, the image sensor module 20 includes a camera lens 21, an infrared septum 22, and an image sensor 23.

The camera lens 21, which focuses an image of the object on the sensor 23, transmits an optical images of the object to the sensor 23. The camera lens 21 is a non-spherical surface lens, and includes a lens part 212 and a mounting part 213. The lens part 212 and the mounting part 213 can be integrally formed using insert molding.

The infrared septum 22 is plated on a surface of the mounting part 213 for filtering out infrared noise. A face of the mounting part 213 can be made planar to ease attachment of the infrared septum 22 thereon.

The image sensor 23 is used to transform optical signals to analog electrical signals and can be made fromCharge Couple Device (CCD) elements or Complementary Metal-Oxide-Semiconductor Transistor (CMOS) elements. The image sensor 23 includes an underlay 231 and several sensitization elements 232. These sensitization elements 232 are made from semiconductor material, such as silicon, and are distributed on a surface of the image sensor 23.

In assembly, the camera lens 21 with the infrared septum 22 assembled thereon, is attached to the image sensor 23, with the infrared septum 22 facing the several sensitization elements 232. A distance between the camera lens 21 and the image sensor 23 is set to equal the focal length of the lens part 212. Then, the mounting part 213 of the camera lens 21 is fixed to the image sensor 23 using hot mold glue 80, such as 353ND epoxy. This kind of glue is more fit for maintaining the optical stability of the digital camera, and can assure that the several sensitization elements 232 get more optical signals.

When the digital camera 10 is in operation, optical signals for the object first come into the camera lens 21 through the shutter (not shown), and are then focused on the sensitization elements 232 of the image sensor 23. At the same time the infrared noise will be eliminated by the infrared septum 22. Second, the optical signals will be transformed to analog signals by the image sensor 23, and then will be transformed to digital signals by the DSP 30. Next, the color reproduction processing will be done by the MCU 40, including automatical focusing, automatical exposal and white balance, and so on. Finally the reproduced image will be stored in the DRAM 50 or will be put out through the output apparatus 60.

The digital camera 10 in accordance with the above description can be reduced in size compared with current technology by using the non-spherical camera lens 21 and plating an infrared septum 22 directly on the camera lens' 21 planar surface. This arrangement allows either a lens-holding apparatus or a baseboard to be omitted. And since the camera lens 21 with the non-spherical surface will not suffer from optical aberration, the optical capability of the digital camera will also be improved.

It is believed that the present invention and its advantages will be understood from the foregoing description and it will be apparent that various changes may be made thereto without departing from the spirit and scope of the invention or sacrificing all of its material advantages, the examples hereinbefore described merely being preferred or exemplary embodiments of the invention.

We claim:

1. A digital camera, comprising:
an image sensor module, comprising a camera lens with a non-spherical surface and an image sensor for transforming optical signals to analog signals, wherein the camera lens is spaced apart from the image sensor;
a Digital Signal Processor (DSP) for transforming analog signals to digital signals;
a Microprogrammed Control Unit (MCU) for processing the digital signals out from the DSP;
a dynamic random access memory (DRAM) for storing data;
an output apparatus; and
a circuitry for connecting the image sensor module, the DSP, the MCU, the DRAM and the output apparatus together.

2. The digital camera as claimed in claim 1, wherein the image sensor further includes an infrared septum.

3. The digital camera as claimed in claim 2, wherein the camera lens further includes a lens part.

4. The digital camera as claimed in claim 2, wherein the camera lens further includes a mounting part.

5. The digital camera as claimed in claim 4, wherein the infrared septum is plating on a face of the mounting part.

6. The digital camera as claimed in claim 1, wherein the image sensor further includes several sensitization elements and an underlay.

7. The digital camera as claimed in claim 1, wherein the camera lens is fixed to the image sensor by hot mold glue.

8. The digital camera as claimed in claim 7, wherein the hot mold glue is 353ND epoxy.

9. A digital camera, comprising:
an image sensor module, comprising a camera lens with a non-spherical surface and an image sensor for transforming optical signals to analog signals, wherein the camera lens is spatially fastened to the image sensor;
a Digital Signal Processor (DSP) for transforming analog signals to digital signals;
a Microprogrammed Control Unit (MCU) for processing the digital signals out from the DSP;
a dynamic random access memory (DRAM) for storing data;
an output apparatus; and
a circuitry for connecting the image sensor module, the DSP, the MCU, the DRAM and the output apparatus together.

10. A method of capturing a picture, comprising:
providing a an image sensor module with a camera lens, which defines a non-spherical surface, and an image sensor for transforming optical signals to analog signals, wherein the camera lens is spatially fastened to the image sensor; and
coating an infrared layer upon a back surface of said lens and between said lens and said image sensor.
